(19) United States
(12) Patent Application Publication
(10) Pub. No.: US 2026/0271074 A1
(43) Pub. Date: Sep. 10, 2026

(54) STATION DEVICE, ACCESS POINT DEVICE, CONTROL METHOD, AND RECORDING MEDIUM

(71) Applicant: CANON KABUSHIKI KAISHA, Tokyo (JP)

(72) Inventor: TOMOYA OTANI, Tokyo (JP)

(21) Appl. No.: 19/664,351

(22) Filed: Apr. 30, 2026

Related U.S. Application Data
(63) Continuation of application No. PCT/JP2024/037184, filed on Oct. 18, 2024.

(30) Foreign Application Priority Data
Nov. 2, 2023 (JP) 2023-188932

(51) Int. Cl. H04W 74/0816; H04W 72/0446

(52) U.S. Cl. CPC H04W 74/0816; H04W 72/0446

(57) ABSTRACT

According to an aspect of the present disclosure, it is aimed at providing a station device that is connectable to an access point device, the station device transmitting, in a case where the station device itself owns a transmission opportunity, an MU-RTS TXS Trigger frame for sharing the transmission opportunity to another communication device.

### CROSS-REFERENCE TO RELATED APPLICATIONS

This application is a Continuation of International Patent Application No. PCT/JP2024/037184, filed October 18, 2024, which claims the benefit of Japanese Patent Application No. 2023-188932, filed November 2, 2023, both of which are hereby incorporated by reference herein in their entirety.

### BACKGROUND

### Field of the Technology

The present disclosure relates to a station device that performs wireless communication, an access point device, a control method, and a recording medium.

### DESCRIPTION OF THE RELATED ART

Institute of Electrical and Electronics Engineers (IEEE) 802.11 standards have been proposed as communication standards related to a wireless local area network (wireless LAN). In an IEEE 802.11be standard and its successor standard, an IEEE 802.11bn standard, a reduction in communication latency and an increase in channel utilization efficiency are being considered.

As a candidate technique, for example, in Japanese Patent Laid-Open No. 2023-145264, a function of sharing a transmission opportunity owned by an access point device with a station device is being considered. The function in question may also be referred to as a Triggered TXOP Sharing function.

When communication is performed between two devices such as an access point device and a station device, in a case where the station device secures a transmission opportunity and transmits data to the access point, for example, the station device may secure a long-term transmission opportunity as a precaution in some cases. In a situation in which the station device secures the transmission opportunity as described above, in order for the station device to receive data from the access point device or the like serving as a counterpart device, the secured transmission opportunity is to be released using a CF-End frame or the like. At this time, in a case where a desired access point device does not succeed in acquiring a channel access, an issue occurs in that transmission of data to be transmitted from the access point device to the station device is delayed. Even in a case where the access point device has succeeded in acquiring a channel access, an issue occurs that a communication overhead associated with a procedure for releasing the transmission opportunity, a procedure for a channel access using CSMA/CA, and the like is large. In addition, as described above, a mechanism for sharing a transmission opportunity owned by an access point (AP) with a station (STA) connected to the AP has already been technically being considered. However, a specific mechanism for sharing a transmission opportunity owned by an STA with another communication device has not been technically considered, and there is an issue that the transmission opportunity owned by the STA is not to be shared with another communication device.

### SUMMARY

The present disclosure has been made in view of at least one of the above-described issues. According to an aspect of the present disclosure, there is provided a scheme for sharing a transmission opportunity owned by a station device with another communication device.

To address the issue, a station device according to an aspect of the present disclosure is a station device connectable to an access point device, the station device including a transmission control unit configured to transmit, in a case where the station device owns a transmission opportunity, an MU-RTS TXS Trigger frame for sharing the transmission opportunity to another communication device.

Features of the present disclosure will become apparent from the following description of embodiments with reference to the attached drawings.

### BRIEF DESCRIPTION OF THE DRAWINGS

FIG. 1 illustrates a configuration of a network system.

FIG. 2 illustrates a hardware configuration of a communication device.

FIG. 3 is a schematic diagram for describing an example of a TXOP Sharing procedure.

FIG. 4A is a schematic diagram for describing an example of a frame format of an MU-RTS TXS Trigger frame.

FIG. 4B is a schematic diagram for describing an example of a frame format of the MU-RTS TXS Trigger frame.

FIG. 4C is a schematic diagram for describing an example of a frame format of the MU-RTS TXS Trigger frame.

FIG. 5A is a table for describing values stored in a field and meanings that those values represent.

FIG. 5B is a table for describing values stored in a field and meanings that those values represent.

FIG. 6 is a flowchart illustrating an example of communication control in a station.

FIG. 7 is a flowchart illustrating an example of communication control in an access point.

FIG. 8 is a schematic diagram for describing a specific example in which a Shared TXOP is used.

### DESCRIPTION OF THE EMBODIMENTS

Hereinafter, embodiments will be described in detail with reference to the accompanying drawings. It is noted that the following embodiments are not intended to limit the invention according to the claims. While a plurality of features are described in the embodiments, not all of the plurality of features are necessarily essential to the invention, and any of the plurality of features may be optionally combined. Furthermore, in the accompanying drawings, the same reference numerals are assigned to identical or similar components, and redundant explanations are omitted.

### First Embodiment

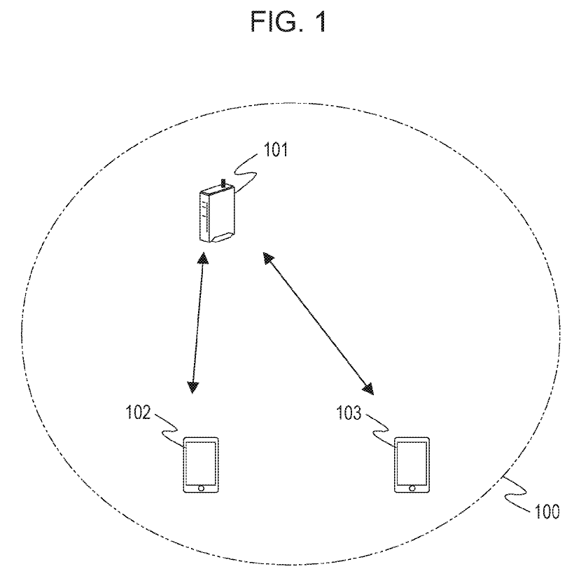

FIG. 1 illustrates a configuration of a network system of the present embodiment. The network system of the present embodiment is constituted by including one access point device (which is hereinafter also simply referred to as an AP, an AP STA, or an access point) and two station devices (each of which is hereinafter also simply referred to as an STA, a Non-AP STA, or a station).

An AP 101 and STAs 102 and 103 are configured to be able to execute communication in a wireless frame compliant with an IEEE 802.11bn standard, which is a successor standard to an IEEE 802.11be standard aiming for a maximum transmission rate of 46.08 Gbps.

It is noted that IEEE is an abbreviation of Institute of Electrical and Electronics Engineers. According to this IEEE 802.11bn, which is a successor standard to IEEE 802.11be, main features include high reliability communication, low latency communication, and an improved throughput during congestion. A wireless frame communicated according to the successor standard is also referred to as an ultra high reliability (UHR) PPDU. PPDU is an abbreviation of physical layer protocol data unit.

It is noted that the term "UHR" is provided for convenience in consideration of an objective to be achieved by the successor standard and a principal feature of the standard, and the term may be changed into a different term in a state in which establishment of the standard has been completed. Similarly, the term "IEEE 802.11bn" may also be changed into a different term in a state in which establishment of the standard has been completed. It should be noted that the present specification and the appended claims are essentially applicable to all successor standards serving as successor standards of the 802.11be standard.

The AP 101 and the STAs 102 and 103 can also be configured to support wireless communication based on other communication standards such as Bluetooth (registered trademark), NFC, and Bluetooth (registered trademark) Low Energy (LE). NFC is an abbreviation of near field communication. In addition, the AP 101 and the STAs 102 and 103 can be configured to support wired communication using an Ethernet cable and wired communication using optical fiber. The AP 101 and the STAs 102 and 103 can also be configured to support wireless communication of cellular methods such as 5G and Long-Term Evolution (LTE). Specific examples of the AP 101 include a wireless LAN router, a personal computer (PC), and the like, but are not limited to these. Each of the AP 101 and the STAs 102 and 103 may also be an information processing apparatus such as a wireless chip that supports transmission and reception of a UHR PPDU. In this case, each device can be configured to execute various types of control by a hardware circuit inside the wireless chip. It is noted that each device can also be configured to execute various types of control in a manner that a processor such as an ASIP inside the wireless chip, a memory, and a hardware circuit operate in cooperation. ASIP is an abbreviation of application-specific instruction set processor.

In addition, specific examples of the STA 102 include a camera, a tablet, a smartphone, a PC, a mobile phone, a video camera, smart glasses, and a wearable device such as a head mounted display (HMD), but are not limited to these.

A description will be provided with reference to FIG. 1 again. The AP 101 is an access point that supports a multi-band function of providing a network in a plurality of different frequency channels. According to the present embodiment, a case is assumed where the AP 101 is an access point in dual bands which is configured to provide, as an example, a network 100 in a 2.4 GHz band and a network 100 in a 5 GHz band which is not illustrated in the drawing.

Furthermore, the AP 101 and the STA 102 of the present embodiment can execute multi-link communication in which a plurality of communication links is established to perform communication between devices. Hereinafter, each of the communication links is also simply referred to as a link. The AP 101 that executes the multi-link communication is also referred to as an AP multi-link device (AP MLD) 101, and the STA 102 that executes the multi-link communication is also referred to as a non-AP MLD 102.

For example, the AP 101 can establish a link in the network 100 in the 2.4 GHz band and perform communication with the STA 102. In addition, in parallel to this, the AP 101 and the STA 102 can establish, for example, a link in the 5 GHz band and perform communication. In this case, the STA 102 executes the multi-link communication in which communication is performed via a plurality of links.

FIG. 1 illustrates a network system in which the STAs 102 and 103 are connected to the single AP 101 as an example, but the number of STAs constituting the network system may be more than the STAs illustrated in FIG. 1. The AP 101 and the STAs 102 and 103 support the UHR PPDU communication (transmission and reception) but can be configured to support, in addition to this, PPDU communication in a legacy standard that is a legacy before the IEEE 802.11bn standard. Specifically, the AP 101 and the STA 102 can also be configured to support PPDU transmission and reception in IEEE 802.11a/b/g/n/ac/ax/be standards and the like.

In addition, frequency bands used by the AP 101 and the STAs 102 and 103 which are connectable to the AP such as the AP 101 are not limited to the 2.4 GHz band and the 5 GHz band described above. For example, different frequency bands such as a 6 GHz band, a sub-1 GHz band, and a millimeter wave band may be used. In addition, the AP 101 and the STA 102 can perform communication by using bandwidths such as 20 MHz, 40 MHz, 80 MHz, 160 MHz, 320 MHz, 540 MHz, and 640 MHz. The bandwidths used by the communication devices are not limited to these.

It is noted that in IEEE 802.11 series of standards, a frequency channel using a frequency band of 20 MHz is specified as a lowest channel in frequency bands of 2.4 GHz, 5 GHz, 6 GHz, and the like. In addition, according to this standard, a plurality of usable channels are defined in each of the frequency bands such as the 2.4 GHz band, the 5 GHz band, and the 6 GHz band. Moreover, according to this standard, it is possible to use a certain channel and another channel adjacent to the certain channel in combination.

The AP 101 and STAs such as the STAs 102 and 103 determine whether or not transmission is permitted by executing carrier sense before data is transmitted. For example, the communication device measures a strength (reception signal strength) of a signal received on a channel that its own device intends to use for the transmission, and in a case where the reception signal strength exceeds a predetermined threshold, it is determined that a signal exists on the channel. In addition, the communication device determines a transmission duration in which the signal is transmitted based on information such as a Duration field included in the signal received on the channel. For example, the communication device stores, in its own device, a duration indicated by the Duration field included in the received signal as a network allocation vector (NAV). The communication device may treat the stored NAV as a duration in which its own device does not perform transmission. An operation by the communication device to set the duration in which its own device does not perform transmission based on the information such as the Duration field of the received signal is also referred to as setting of a NAV. In a case where the communication device determines that a signal exists on the channel by carrier sense or a case where the duration of the set NAV is not expired, it may be determined that transmission is not permitted. A state of the channel in this case may be referred to as a busy state. On the other hand, in a state in which a signal is not detected on the channel by the carrier sense and a NAV is not set, the state may be referred to as an idle state. In a case where the channel is in the idle state, the communication device may determine that transmission is permitted. For example, the AP 101 and the STAs 102 and 103 may perform, for example, transmission of a PPDU with a bandwidth of 160 MHz and the like in a case where it is determined that transmission is permitted as a result of execution of the carrier sense on the channel over a predetermined duration.

In addition, the AP 101 supports a Triggered TXOP Sharing function of sharing the transmission opportunity secured by the AP 101 itself with an STA such as the STA 102 or the STA 103 connected to the AP 101. The AP 101 appropriately grasps types and the amounts of data stored in transmission buffers of subordinate STAs based on buffer status report (BSR) frames or the like. The AP 101 can share the transmission opportunity secured by itself with any one of the subordinate STAs based on the types and the amounts of data stored in the transmission buffers of the subordinate STAs. At this time, the AP 101 can start to share the transmission opportunity by transmitting an MU-RTS TXS Trigger frame specified in the IEEE 802.11be standard. TXS is an abbreviation of Triggered TXOP Sharing.

When communication is performed between two devices such as the access point device and the station device, in a case where the station device secures the transmission opportunity and transmits data to the access point device or the like, the station device may secure a long-term transmission opportunity as a precaution in some cases. This securing of the transmission opportunity is carried out through a procedure of RTS-CTS exchange. RTS is an abbreviation of request to send, and CTS is an abbreviation of clear to send. In a situation where the station device secures the transmission opportunity in this manner, in order for the station device to receive data from the access point device or the like serving as a counterpart device, the secured transmission opportunity is to be released using a CF-End frame or the like. When the transmission opportunity is released, surrounding devices including a desired access point device contend for a channel access. At this time, in a case where the desired access point device does not succeed in acquiring a channel access, transmission of data to be transmitted from the access point device to the station device is delayed. Even in a case where the access point device has succeeded in acquiring a channel access, a communication overhead associated with a procedure for releasing the transmission opportunity, a procedure for a channel access using CSMA/CA, and the like may occur. CSMA/CA is an abbreviation of carrier sense multiple access with collision avoidance.

In view of the above, according to the present embodiment, a scheme in which the transmission opportunity owned by the STA is shared with another communication device is provided. More specifically, a communication rule is changed when necessary so as to allow an STA to transmit an MU-RTS TXS Trigger frame which is previously allowed to be transmitted only by an AP. In addition, along with the change, the MU-RTS TXS Trigger frame is extended such that information used when sharing of the transmission opportunity from the STA is performed and information for enhancing its convenience can be stored. By using the extended frame, it becomes possible to share the transmission opportunity owned by the STA with another communication device. Hereinafter, a specific scheme will be described. It is noted that the MU-RTS TXS Trigger frame is also referred to as TXS TF or the like.

### Hardware Configuration of Communication Devices

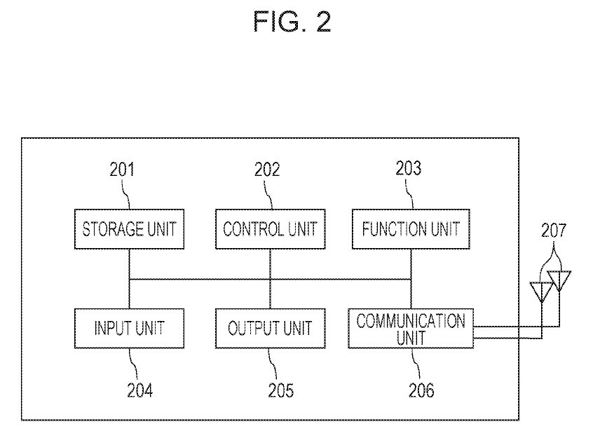

FIG. 2 illustrates a hardware configuration example of each of the communication devices (the AP 101 and the STAs 102 and 103). The communication device includes, as an example of its hardware configuration, a storage unit 201, a control unit 202, a function unit 203, an input unit 204, an output unit 205, a communication unit 206, and an antenna 207.

The storage unit 201 is constituted by both or either one of a ROM and a RAM and stores various types of information such as a program for performing various types of operations which will be described below, a communication parameter for wireless communication, and the like. RAM is an abbreviation of random-access memory, and ROM is an abbreviation of read only memory. It is noted that in addition to a memory such as a ROM or a RAM, a storage medium such as a non-volatile storage device including a hard disk, a solid-state drive (SSD), or the like may be used as the storage unit 201.

The control unit 202 is constituted, for example, by a processor such as a CPU or an MPU, an application specific integrated circuit (ASIC), a digital signal processor (DSP), a field programmable gate array (FPGA), or the like. Herein, CPU is an abbreviation of central processing unit, and MPU is an abbreviation of micro processing unit. The control unit 202 controls the entire device by executing the program stored in the storage unit 201 and also causing a hardware circuit such as an ASIC to operate. It is noted that the control unit 202 may be configured to control the entire device through cooperation between the program stored in the storage unit 201 and an operating system (OS).

In addition, the control unit 202 controls the function unit 203 to execute predetermined processing such as image capturing, printing, or projection. The function unit 203 is hardware used by the device to execute predetermined processing. For example, in a case where the communication device is a camera such as a digital still camera or a smartphone including a camera, the function unit 203 is an image capturing unit. The image capturing unit performs image capturing processing of an image in a surrounding environment via a camera unit which is not illustrated in the drawing and which is included in the communication device. For example, in a case where the communication device is a printer, the function unit 203 is a printing unit. The printing unit performs printing processing on a sheet such as paper based on printing data obtained through wireless communication from the outside. For example, in a case where the communication device is a projector or smart glasses, the function unit 203 is a projection unit. The projection unit performs projection processing of image data or video data obtained through wireless communication from the outside. In a case where the communication device is smart glasses, a projection surface is an end user's retina or the like. In a case where the communication device is an HMD, the function unit 203 may be a display unit of a micro organic light emitting diode (OLED) or the like. In this case, the display unit constituting the HMD performs display processing of image data or video data obtained through wireless communication from the outside.

Data processed by the function unit 203 may be data stored in the storage unit 201 or data communicated with another AP or an STA via the communication unit 206 which will be described below. Furthermore, the communication device such as the AP 101 can provide a network storage function such as a network attached storage (NAS). The function is provided as a web service such as a network storage service to another communication device. For example, a communication device such as the STA connects to the network storage service provided by the AP 101 or the like by using a protocol such as SMB, FTP, WebDAV, or the like. The communication device such as the STA then uploads a file to the storage service or downloads a file in the storage. Data communication for the upload and the download is also realized by communicating a UHR PPDU between the devices.

The input unit 204 accepts various types of operations from the user. The output unit 205 performs various types of outputs to the user. Herein, the output by the output unit 205 includes, for example, at least one of display on a screen, audio output through a speaker, and vibration output. It is noted that both the input unit 204 and the output unit 205 may be realized by a single module such as a touch panel.

The output unit 205 functions as a display unit configured to present information to the user. The input unit functions as an acceptance unit configured to accept operations from the user.

The communication unit 206 performs control of wireless communication compliant with IEEE 802.11 series of standards and control of IP communication. According to the present embodiment, in cooperation with the antenna 207, the communication unit 206 can execute transmission control to transmit and reception control to receive a UHR PPDU serving as a wireless frame of the 802.11bn standard or a PPDU corresponding to its predecessor standard. The antenna 207 is an antenna that can transmit and receive, for example, a signal in a frequency band of at least one of a sub-GHz band, the 2.4 GHz band, the 5 GHz band, the 6 GHz band, and the millimeter wave band. It is noted that according to the present embodiment, a communication device provided with two antennas is exemplified as an example but is not limited to this. The number of antennas may be three or more.

It is noted that in a case where the communication device supports the NFC standard, the Bluetooth standard, the wired communication standard, and the like described above, the communication unit 206 may be configured to control wireless communication and wired communication compliant with these communication standards.

### Transmission Opportunity Sharing Processing

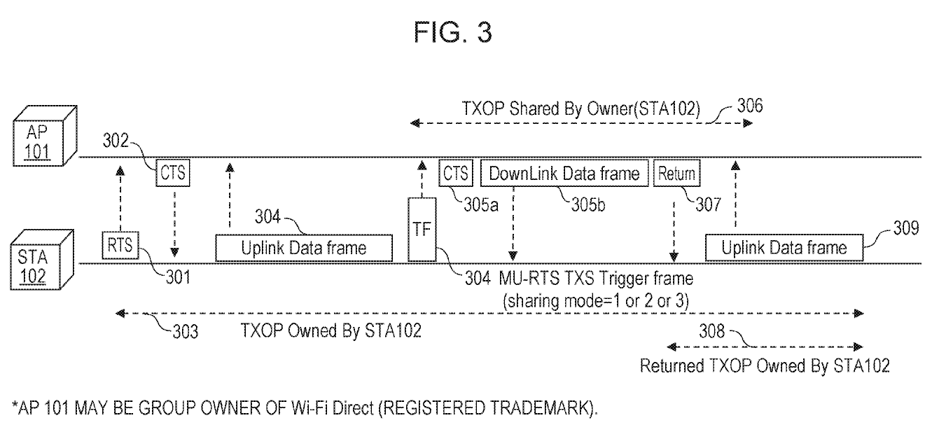

Subsequently, an example of transmission opportunity sharing processing according to the present embodiment will be described with reference to FIG. 3. FIG. 3 is a schematic diagram illustrating an example of processing for the STA according to the present embodiment to share a transmission opportunity with another communication device.

First, the STA 102 transmits an RTS frame 301 to the AP 101. The STA 102 stores, in a Duration field of the RTS frame, a duration corresponding to a transmission opportunity that the STA 102 desires to own. The AP 101 that has received the RTS frame 301 transmits a CTS frame 302 to the STA 102. The AP 101 stores, in a Duration field of the CTS frame, the duration corresponding to the transmission opportunity owned by the STA 102. When exchange of the RTS frame and the CTS frame is successful, the STA 102 is put into a state in which a channel corresponding to the network 100 can be occupied to perform data transmission. A duration 303 indicates the transmission opportunity owned by the STA 102. The transmission opportunity is also referred to as TXOP. TXOP is an abbreviation of transmission opportunity.

The STA 102 that has owned a TXOP transmits an uplink data frame 304 to the AP 101. The data frame is a data frame in a UHR PPDU format.

Subsequently, the STA 102 determines whether or not the transmission opportunity is to be shared with another communication device such as the AP 101. The STA 102 can determine, based on a trend of a past communication history or the like, whether or not the transmission opportunity is to be shared with another communication device. It is noted that in FIG. 3, as an example, a case where it is determined that the transmission opportunity is shared with the AP 101 is exemplified.

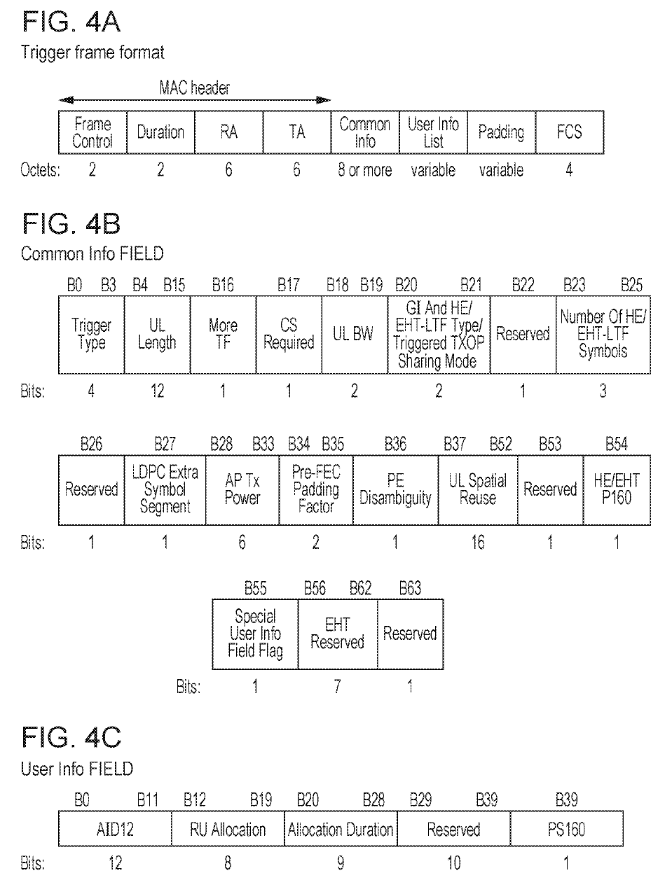

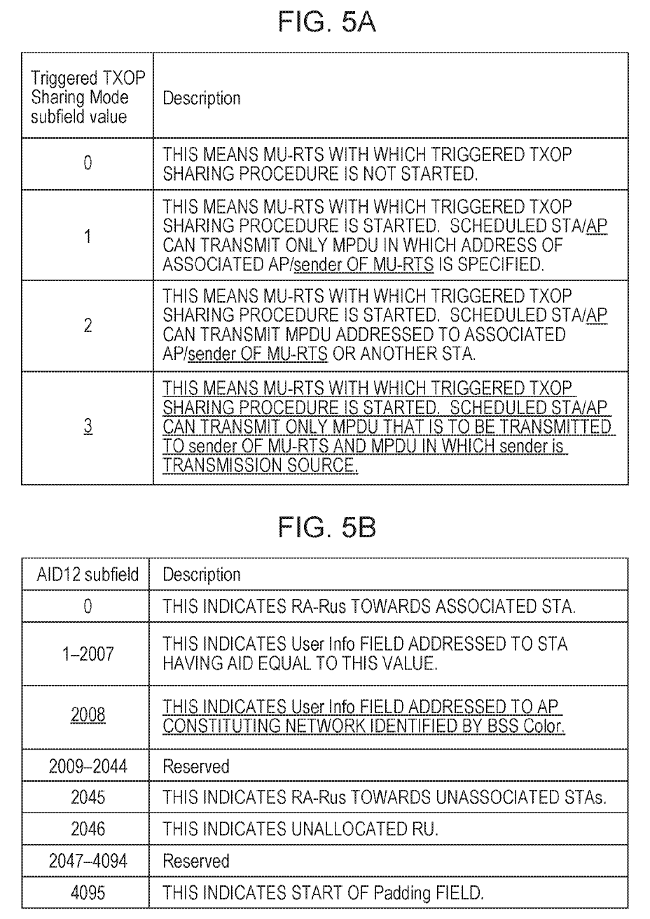

The STA 102 that has determined that the transmission opportunity is to be shared with the AP 101 transmits the MU-RTS TXS Trigger frame 304 for sharing the transmission opportunity to the AP 101. A detail of the frame 304 will be described with reference to FIG. 4A to FIG. 4C, FIG. 5A, and FIG. 5B. The AP 101 that has received the frame 304 transmits a CTS frame 305a as a response to the frame 304. Subsequently, the AP 101 decides, based on a type of a TXOP Sharing Mode indicated by the frame 304 and transmission data stored in a buffer, data that is to be transmitted during a duration 306 of the TXOP shared by using the frame 304. Hereinafter, the TXOP shared by using the frame 304 is also referred to as Shared TXOP. In FIG. 3, as an example, a case is exemplified where downlink data addressed to the STA 102 is decided as the data that is to be transmitted.

The AP 101 transmits a downlink data frame 305b to the STA 102 during the duration of the Shared TXOP. In a case where data that is to be transmitted during the duration of the Shared TXOP does not exist, a frame 307 including information meaning that the TXOP is to be returned is transmitted to the STA 102. It is assumed that the frame 307 is a frame including a CAS Control field, that is a frame in which "0" is set in an RDG/More PPDU subfield included in the CAS Control field. This CAS Control field is assumed to be included in an HE Variant HT Control field.

It is noted that the frame 305b and the frame 307 may be included in the same UHR PPDU. In addition, the frame 307 may be a QoS Null frame.

The STA 102 that has received the frame 307 determines whether or not data that is to be transmitted during a duration 308 corresponding to the remaining TXOP exists. When it is determined that data that is to be transmitted exists, a data frame is transmitted to the outside. FIG. 3 exemplifies a case where an uplink data frame 309 to the AP 101 is transmitted as an example.

Subsequently, with reference to FIG. 4A to FIG. 4C, FIG. 5A, and FIG. 5B, a specific format of the MU-RTS TXS Trigger frame 304 generated and transmitted by a STA such as the STA 102 for sharing the transmission opportunity with another communication device will be described.

FIG. 4A to FIG. 4C illustrate specific formats of the MU-RTS TXS Trigger frame. In addition, FIG. 5A and FIG. 5B are tables for describing values that can be stored in a subfield of the MU-RTS TXS Trigger frame and their meanings.

A Frame Control field includes a Type subfield indicating a frame type and a Subtype subfield. The STA sets "01" indicating a Control frame in the Type subfield and "0010" indicating Trigger in the Subtype subfield, so that the frame indicates a trigger frame. A Duration field, an RA field, and a TA field conform to content of a MAC header of a trigger frame serving as a control frame defined in the IEEE 802.11ax standard. MAC is an abbreviation of medium access control.

RA is an abbreviation of receiver address, and a MAC address of a destination device is stored in the RA field. TA is an abbreviation of transmitter address, and a MAC address of a transmitter device is stored in the TA field. It is noted that a broadcast address is stored in the RA field of the trigger frame.

Subsequently, a Common Info field is a field for storing information common to the trigger frame and includes each subfield illustrated in FIG. 5B. A User Info List field stores one Special User Info field which is not illustrated in the drawing and one User Info field exemplified in FIG. 4C. The Special User Info field is a field for storing shared information that does not fit in the Common Info field. The User Info field is a field for storing information for specifying a counterpart with which the TXOP is shared, information indicating a duration thereof, information for specifying a bandwidth to be shared, and the like. A Padding field is a field for storing padding data, an FCS field is a field for storing information used in a frame check sequence (FCS) for inspecting whether or not the frame is corrupted during transmission.

Subsequently, the Common Info field will be described with reference to FIG. 5B. FIG. 5B exemplifies a case where an EHT Variant Common Info field is used. A Trigger Type subfield stores "3" indicating an MU-RTS (multi-user RTS) type. A More TF subfield stores "0". A CS Required subfield stores "1" or "0". In a case where the TXS TF is transmitted in a congested environment, the STA 102 stores "1" in the CS Required subfield. Storing "1" in the CS Required subfield means that carrier sense is needed at a counterpart with which the transmission opportunity is shared. Storing "0" means that carrier sense does not necessarily need to be performed at the counterpart. A UL BW subfield is a subfield indicating a bandwidth of a PPDU for transmitting a trigger frame of an MU-RTS type. A value of the subfield and a value of UL Bandwidth Extension of the Special User Info field are combined to indicate the bandwidth of the PPDU.

A GI And HE/EHT-LTF Type/Triggered TXOP Sharing Mode field stores a type of a Triggered TXOP Sharing mode. Subsequently, a Special User Info Field Flag subfield stores "0". Storing "0" means that the Special User Info field is provided.

Other UL Length, LDPC Extra Symbol Segment, Number of HE/EHT-LTF Symbols, AP Tx Power, Pre-FEC Padding Factor, PE Disambiguity, UL Spatial Reuse, and HE/EHT P160 subfields are fields for storing information used in a trigger frame of another trigger type. In the case of the TXS TF that is of the MU-RTS type, the field is treated as a reserved value. Each of a Reserved subfield and an EHT Reserved subfield is also treated as a reserved value.

Subsequently, a format of the User Info field will be described with reference to FIG. 4C. FIG. 4C exemplifies a case where an EHT Variant User Info field is used. In an AID12 subfield, information for specifying a counterpart with which a TXOP is shared is stored. In a case where the TXOP is shared with an AP such as the AP 101, since an AID is not allocated to the AP, a specific value meaning that this is addressed to the AP is set. A detail will be described below. An RU Allocation subfield is a subfield indicating on which channel among a primary 20 MHz channel, a primary 40 MHz channel, a primary 80 MHz channel, a primary 160 MHz channel, and a 320 MHz channel a CTS frame that is a response to the TXS TF is to be transmitted. An Allocation Duration subfield is a subfield for storing a duration of a transmission opportunity shared with another communication device, that is, a Shared TXOP. A PS160 subfield stores "1" in a case where this indicates the 320 MHz channel. The PS160 subfield stores "0" in a case where this does not indicate the 320 MHz channel. A Reserved subfield is treated as a reserved value.

Subsequently, with reference to FIG. 5A, meanings of values stored in a Triggered TXOP Sharing Mode subfield will be described. Storing "0" means a mere MU-RTS with which a procedure to share a TXOP is not executed. Storing "1" means that only an MPDU with an address of the AP or the sender of MU-RTS specified can be transmitted. More specifically, in a case where the AP shares a TXOP with a STA, this means that during the Shared TXOP, only transmission of data addressed to the AP is permitted. On the other hand, as in the present embodiment, in a case where a STA shares a TXOP with an AP or another communication device, this means that during the Shared TXOP, only transmission of data addressed to the STA that has transmitted a TXS TF is permitted. MPDU is an abbreviation of MAC protocol data unit and means a so-called MAC frame. It is noted that the MPDU set as a transmission target may be an aggregated aggregation-MAC protocol data unit (A-MPDU).

Storing "2" means that a destination of data transmission during the Shared TXOP is not limited. Data transmission to the AP is permitted, data transmission to the STA that has transmitted the TXS TF is also permitted, and data transmission to another STA is also permitted.

Storing "3" means that only transmission of an MPDU addressed to the STA that has transmitted the TXS TF and transmission of an MPDU in which the STA that has transmitted the TXS TF is stored in an SA field are permitted. That is, this means that only data transmission associated with the STA that is the sender of the TXS TF is permitted during the Shared TXOP.

The communication device such as the AP 101 with which the TXOP is shared from the STA 102 specifies a type of permitted transmission data corresponding to a Sharing Mode indicated by the TXS TF. Subsequently, data to be transmitted during the Shared TXOP is decided by taking into account the specified type of permitted transmission data, a priority level of data stored in the buffer, and the like.

Furthermore, with reference to FIG. 5B, meanings of values stored in the AID12 subfield of the User Info field will be described. Storing "0" or "2045" indicates that this is a random access-resource unit (RA-RU). The RA-RU is used for an uplink random access procedure. Storing "2046" means that this is an unallocated resource unit (RU). These values are values used when a trigger frame of another trigger type is used and are not used for the TXS TF. Here, "4095" means start of the Padding field and is not used in the User Info field. All bits in the above-described Padding field are set to "1". When expressed in binary, "4095" is represented by twelve consecutive bits set to "1". A reception terminal that has recognized that twelve consecutive bits are set to "1" can recognize that reception of the User Info field is completed, and a phase has reached an interpretation phase of the Padding field.

On the other hand, a value from 1 to 2007 means that this is a User Info field addressed to a STA an Association Identifier (AID) of which is equal to that value. The AID is identification information assigned to a STA when the STA connects to the AP, and is used to identify the STA. Within the same network, the AID is assigned with a value that does not overlap with those of other STAs so that the counterpart STA can be uniquely specified. In other words, storing any value from 1 to 2007 in the AID12 subfield means providing information for specifying the counterpart STA with which the TXOP is shared.

According to the present embodiment, as an example, "2008" is used as a specific value for specifying the above-described AP. Storing "2008" in the AID12 subfield means that this is User Info addressed to the AP corresponding to a BSS Color value included in a PHY preamble of the UHR PPDU including the TXS TF. First, BSS Coloring will be described. BSS Coloring is a mechanism for specifying, by assigning an identifier called a color code to a physical layer frame, which network a frame is intended for in an environment where access points are densely arranged. An AP such as the AP 101 sets a BSS Color for itself that is different from that of a neighboring AP and also shares the BSS Color with subordinate STAs. When a frame is transmitted, the AP or the STA includes the BSS Color corresponding to the network to which the AP or the STA itself belongs in a U-SIG of the PHY preamble. U-SIG is an abbreviation of universal signal field. The AP or the STA compares the BSS Color of the network managed by itself with a value of the BSS Color field of the PHY preamble. Then, the AP or the STA can distinguish, based on whether or not a comparison result matches, whether the frame is addressed to the network to which the device itself belongs or addressed to another network present in the vicinity. This scheme is provided to mainly realize OBSS_PD-based spatial reuse.

The AP or the STA that has determined through the above-described comparison processing that this is a PPDU addressed to the network to which the device itself belongs interprets a MAC frame included in a data portion of the PPDU. Therefore, when a PPDU including a TXS TF that is a MAC frame is received, interpretation of the TXS TF is performed. As a result of the interpretation, in a case where "2008" is stored in the AID12 subfield of the TXS TF, this can be identified as the TXS TF for the specific STA to share the TXOP with the AP belonging to the same network. When the device itself is the AP in the same network, it may be determined that the TXOP has been shared and may be used for data transmission as appropriate. On the other hand, when the device itself is the STA belonging to the same network or does not belong to the same network, a NAV may be set.

### Communication Control

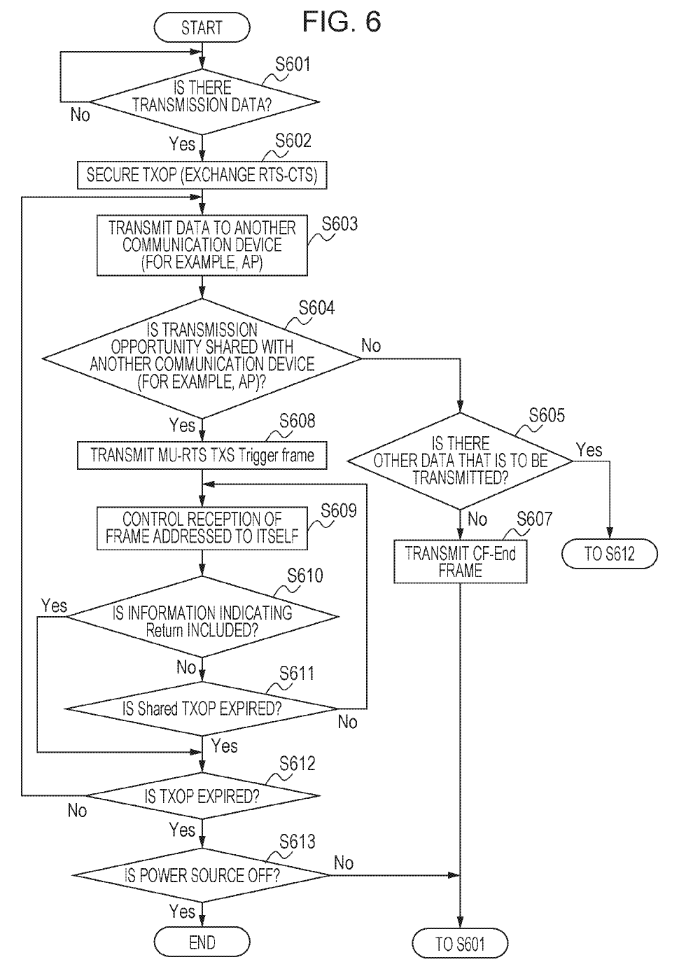

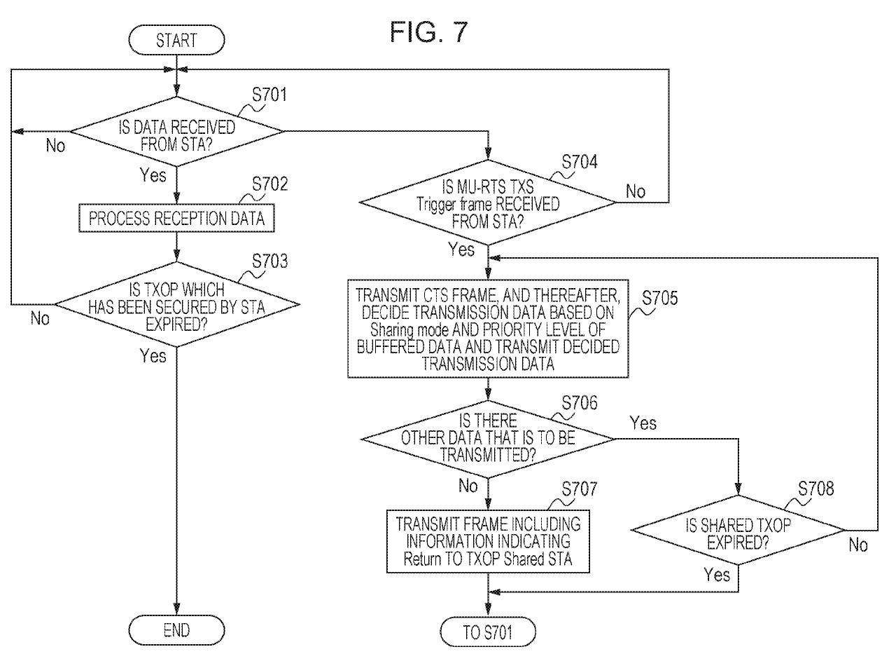

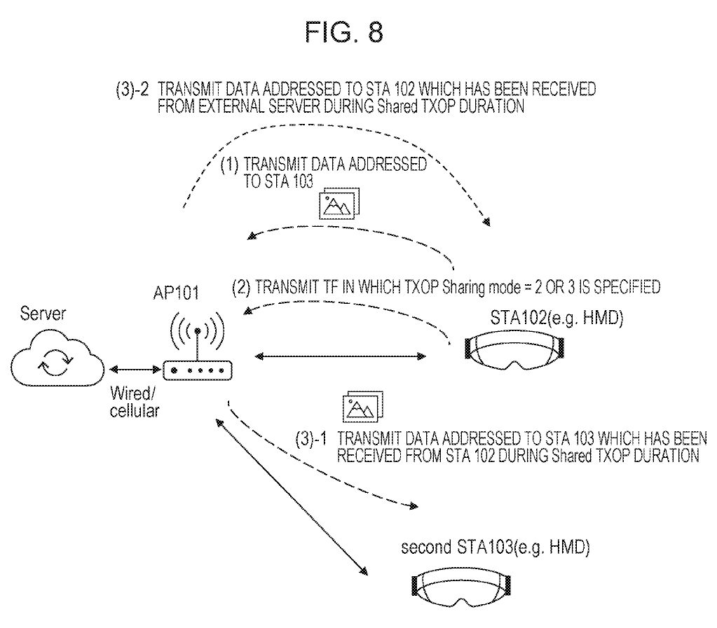

Subsequently, communication control of sharing a TXOP of the present embodiment will be described by using flowcharts of FIG. 6 and FIG. 7 and a schematic diagram of FIG. 8. FIG. 8 is a schematic diagram for describing a specific example in which a Shared TXOP is used.

Each processing illustrated in the flowchart of FIG. 6 is executed when a processor of the control unit 202 of the STA represented by the STA 102, the STA 103, or the like executes a computer program stored in the storage unit 201. It is noted that some processes such as transmission and modulation are realized through cooperation among the processor of the control unit 202, various types of processors, an ASIC, a DSP, and an FPGA constituting the communication unit 206, and the antenna, and an ASIC, a DSP, and an FPGA constituting the control unit 202, and the like. It is noted that the configuration is not limited to this, and it is also naturally possible to adopt a configuration in which a control unit such as an ASIC or a processor inside the communication unit 206 and the antenna cooperate with each other to execute each process illustrated in the flowchart. In addition, each process illustrated in the flowchart of FIG. 7 is executed when the processor of the control unit 202 of the AP 101 executes the computer program stored in the storage unit 201. It is noted that some processes such as transmission and modulation are realized through cooperation among the processor of the control unit 202, various types of processors, an ASIC, a DSP, and an FPGA constituting the communication unit 206, and the antenna, and an ASIC, a DSP, and an FPGA constituting the control unit 202, and the like. It is noted that the configuration is not limited to this, and it is also naturally possible to adopt a configuration in which a control unit such as an ASIC or a processor inside the communication unit 206 and the antenna cooperate with each other to execute each process illustrated in the flowchart.

It is noted that FIG. 6 and FIG. 7 are flowcharts in which control related to TXOP sharing closely associated with the present embodiment is extracted.

In S601, the control unit 202 of the STA represented by the STA 102, the STA 103, or the like determines whether or not transmission data exists. Specifically, in a case where the control unit 202 determines whether or not transmission data (MAC frame such as a data frame) is stored in the transmission buffer, and in a case where it is determined that transmission data is stored in the transmission buffer, the flow proceeds to S602. On the other hand, in a case where it is determined that transmission data is not stored in the transmission buffer, the flow waits for storage of transmission data.

Subsequently, in S602, the control unit 202 performs processing of securing a TXOP in cooperation with each of the units such as the communication unit 206 and the antenna 207. Specifically, the procedure of the RTS-CTS exchange described with reference to FIG. 3 is executed to secure a TXOP.

Subsequently, in S603, the control unit 202 transmits a UHR PPDU including the transmission data to another communication device such as the AP 101 in cooperation with each unit. Subsequently, in S604, the control unit 202 determines whether or not the transmission opportunity is to be shared with another communication device such as an AP. In a case where it is determined that the transmission opportunity is to be shared with another communication device such as an AP, the flow proceeds to S608. On the other hand, in a case where it is not determined that the transmission opportunity is not to be shared with another communication device such as an AP, the flow proceeds to S605. Specifically, the control unit 202 can determine whether or not the transmission opportunity is to be shared with another communication device such as an AP based on a trend of the past communication history or the like.

In S605, the control unit 202 determines whether or not other data that is to be transmitted exists. Specifically, in a case where transmission data is stored in the transmission buffer, it is determined that other data that is to be transmitted exists. In a case where it is determined that other data that is to be transmitted exists, the flow proceeds to S612. In a case where it is not determined that other data that is to be transmitted exists (that is, in a case where data that is to be transmitted does not exist), the flow proceeds to S607.

In S607, the control unit 202 transmits a PPDU including a CF-End frame in cooperation with each unit, and the flow proceeds to S601. Processing to transmit the frame means that the remaining TXOP is released.

Subsequently, control in a case where it is determined that the TXOP is to be shared with another communication device will be described.

In S608, the control unit 202 generates an MU-RTS TXS Trigger frame for sharing a TXOP with another communication device. Subsequently, the control unit 202 transmits the generated MU-RTS TXS Trigger frame in cooperation with each unit. At this time, the control unit 202 decides a value of a TXOP Sharing Mode to be included in the TXS TF based on a trend of the past communication history or the like. For example, based on a trend of the past communication history or the like, in a case where it is estimated that data that is desired to be received from the AP exists, "1" is set to TXOP Sharing Mode. In a case where transmission data to be transmitted to the AP that is transmission data with a destination of another communication device (for example, the STA 103) or the like is estimated to be swiftly communicated to still another communication device such as the STA 102, "2" or "3" is set to the TXOP Sharing Mode. It is noted that in a case where a counterpart with which the TXOP is shared is the AP, the control unit 202 stores "2008" in the AID12 subfield of the MU-RTS TXS Trigger frame.

Subsequently, in S609, the control unit 202 performs reception control of a frame addressed to itself in cooperation with each unit. In a case where a frame addressed to itself is received, the control unit 202 appropriately receives the frame and interprets a data frame and a control frame included in the frame to perform control based on an interpreted result and forwards data obtained as a result of the interpretation to an upper layer such as an IP layer which is not illustrated in the diagram.

In S610, the control unit 202 determines whether or not information indicating Return for returning the TXOP is included in the frame. Specifically, in a case where a frame in which "0" is set in the RDG/More PPDU subfield included in the CAS Control field or a QoS Null frame is received, it is determined that the information indicating Return is included. In a case where it is determined that the information indicating Return is included, the flow proceeds to S612, and in a case where it is not determined that the information indicating Return is included, the flow proceeds to S611. In S611, it is determined whether or not the Shared TXOP shared with the other communication device based on the frame in S608 is expired. When it is determined that the Shared TXOP is expired, the flow proceeds to S612. When it is determined that the Shared TXOP is not expired, the flow proceeds to control in S609, and reception control and monitoring control for returning the TXOP are performed.

In S612, the control unit 202 determines whether or not the TXOP secured in S602 is expired. In a case where it is determined that the TXOP is expired, the flow proceeds to S613. On the other hand, in a case where it is determined that the TXOP is not expired (that is, a case where it is determined that the secured TXOP still remains), the flow proceeds to S603.

In S613, it is determined whether or not a power source is to be turned OFF. In a case where it is determined that the power source is to be turned OFF, shutdown control is performed to end the series of control. On the other hand, in a case where it is determined that the power source is not to be turned OFF, the flow proceeds to S601.

Through the series of processing described above, the STA device such as the STA 102 can share the TXOP with the other communication device represented by the AP 101 or the like and urge another desired communication device to transmit data to itself and to perform other data forward processing.

Subsequently, control in another communication device which receives sharing of a TXOP will be described with reference to FIG. 7. According to the present embodiment, an example in which the AP 101 receives sharing of a TXOP from the STA 102 will be described.

In S701, the control unit 202 of the AP 101 determines whether or not data addressed to the AP 101 is received from the STA such as the STA 102 in cooperation with each of the units such as the communication unit 206 and the antenna 207. When it is determined that data addressed to itself is received from the STA such as the STA 102, the flow proceeds to S702, and when it is determined that data addressed to itself is not received from the STA such as the STA 102, the flow proceeds to S700, and control to wait for data reception is performed. It is noted that at this time, the STA serving as the counterpart device may secure a TXOP in advance through RTS-CTS exchange in advance and then transmit the frame. In addition, the counterpart device may transmit the frame and secure the TXOP at the same time. In this case, a frame is transmitted in which a TXOP corresponding to a transmission time period of the frame (or an exchange time period including an immediate ACK) is stored in the TXOP field of the U-SIG of the PHY preamble and the Duration field of the MAC frame. In this case, the transmission time period of the frame (or the exchange time period including the immediate ACK) and the TXOP become equal to each other. The control unit 202 temporarily stores the TXOP secured by the counterpart device.

In S702, the control unit 202 performs reception control of a frame addressed to itself in cooperation with each unit. In a case where a frame addressed to itself is received, the control unit 202 receives the frame as appropriate, interprets a data frame and a control frame included in the frame, performs control based on a result of the interpretation, and forwards data obtained as a result of the interpretation to an upper layer such as an IP layer which is not illustrated in the drawing.

In S703, the control unit 202 determines whether or not the TXOP secured by the STA serving as the counterpart device is expired. When it is determined that the TXOP secured by the STA is expired, the series of reception processing is ended. On the other hand, when it is determined that the TXOP secured by the STA is not expired, the flow returns to S701 and waits for further data reception.

In S704, the control unit 202 determines whether or not the MU-RTS TXS Trigger frame addressed to the AP 101 is received from the STA such as the STA 102 in cooperation with each unit. When it is determined that the MU-RTS TXS Trigger frame addressed to the AP 101 is received, the flow proceeds to S705, and when it is determined that the MU-RTS TXS Trigger frame addressed to the AP 101 is not received, the flow proceeds to S701. Specifically, it is determined whether or not the MAC frame included in the data portion of the PPDU identified to have the same BSS Color is a trigger frame of the MU-RTS type. Subsequently, it is determined whether or not "1", "2", or "3" is designated in the GI And HE/EHT-LTF Type/Triggered TXOP Sharing Mode field of the trigger frame. In a case where this is the trigger frame of the MU-RTS type and "1", "2", or "3" is designated in the Sharing Mode field, it is determined that the MU-RTS TXS Trigger frame is received. In this case, furthermore, when "2008" is designated in the AID12 subfield of the frame, it is determined that the MU-RTS-TXS Trigger frame addressed to itself is received. When "2008" is not designated in the AID12 subfield, it is determined that the MU-RTS TXS Trigger frame addressed to itself is not received. It is noted that although illustration is omitted due to a space limitation, in a case where another control frame is received, the control unit 202 appropriately performs control corresponding to the other control frame that has been received.

In S705, the control unit 202 performs control in cooperation with each unit to transmit the CTS frame to a channel specified based on a value designated in the RU Allocation subfield and a bandwidth in which the PPDU of the TXS TF is transmitted. Subsequently, the control unit 202 performs control to decide and transmit transmission data based on a Triggered TXOP Sharing Mode indicated by the TXS TF and a priority level of data buffered in the transmission buffer.

In S706, the control unit 202 determines whether or not other data that is to be transmitted exists. In a case where it is determined that other data that is to be transmitted exists, the flow proceeds to S708, and in a case where it is determined that other data that is to be transmitted does not exist, the flow proceeds to S707.

In S707, the control unit 202 transmits a frame including information indicating Return for returning the TXOP in cooperation with each unit. Specifically, the control unit 202 may transmit a frame in which "0" is set in the RDG/More PPDU subfield included in the CAS Control field or a QoS Null frame.

In S708, the control unit 202 determines whether or not the shared TXOP is expired. In a case where it is determined that the shared TXOP is expired, the flow proceeds to S701, and in a case where it is determined that the shared TXOP is not expired (that is, a case where the Shared TXOP that can be used for data transmission still remains), the flow proceeds to S705.

Through the processing described above, it becomes possible for the AP 101 to perform data transmission by using the Shared TXOP.

A supplementary description is provided regarding control in a case where the Shared TXOP is successful. There is a rule that in a case where transmission is successful during a duration of a Shared TXOP, a non-AP EHT STA of IEEE 802.11be sets a parameter used for contention access to be disadvantageous. Specifically, the STA that has successfully performed the transmission during the duration of the Shared TXOP needs to use a disadvantageous parameter indicated by an MU EDCA parameter as an EDCA parameter for a certain period of time indicated by an MU EDCA Timer. EDCA is an abbreviation of enhanced distributed channel access, and MU EDCA is an abbreviation of multi-user EDCA.

On the other hand, even in a case where data transmission during the Shared TXOP shared based on the TXS TF is successful, the AP 101 of the present embodiment performs control such that the EDCA parameter is not changed to a disadvantageous parameter corresponding to the MU EDCA parameter. This control is performed by taking into account a possibility that making contention access of a communication device having a role of an AP which manages a network in an overall manner disadvantageous may lead to a decrease in an overall efficiency of the network.

Finally, a specific example in which a Shared TXOP is used will be described with reference to FIG. 8. For example, a case will be considered where an external server, the STA 102 such as an HMD, and the nearby STA 103 such as a nearby HMD operate in coordination to constitute an interactive application system or game system. In particular, it is assumed that the STA 102 performs live streaming or the like in the game system and tends to secure a TXOP as much as possible.

In this case, basically, it is expected that data traffic from the STA 102 to the outside is increased. However, in addition to this, there may be cases where small-volume data or information is desired to be transmitted from the STA 102 to the nearby STA 103, and small-volume data or information may be provided from the external server to the STA 102. In view of these, by appropriately sharing the TXOP with the AP 101, the STA 102 realizes data communication of the use case in question. For example, the STA 102 transmits, to the AP 101, data addressed to the STA 103 by using the TXOP secured by itself. Subsequently, the STA 102 that estimates that the data is to be swiftly forwarded to the STA 103 transmits a TXS TF in which "2" or "3" is stored in the TXOP Sharing Mode. The AP 101 that has received the TXS TF forwards, to the STA 103, the data addressed to the STA 103 received from the STA 102 during the Shared TXOP duration. In addition, during the Shared TXOP duration, the AP 101 transmits data addressed to the STA 102 received from the external server or the like.

Estimation processing on whether or not the TXOP is to be shared may be realized by an application and a communication layer below the IP layer in cooperation with each other. Whether or not the TXOP is to be shared may also be estimated by using only the communication layer below the IP layer based on information such as a priority level of transmission designated by the application. In addition, the above-described past communication history or the like may be used for the estimation.

### Modified Example

According to the above-described embodiment, the case has been exemplified where it is indicated, by designating "2008" that is a specific value in the AID12 subfield in the TXS TF, that this is addressed to the AP. However, the specific value is not limited to this. Any value that does not fall within a range from 0 to 2007 and that does not correspond to any of "2045", "2046", and "4095", that is, any value currently set as Reserved may be defined as the specific value indicating that this is addressed to the AP. For example, "2047", "4094", or the like may be defined as the specific value.

In addition, it is possible to indicate that this is addressed to an AP through a combination with a value in another field. For example, any of the Reserved subfields of the Common Info field may be repurposed as a field for identifying whether this is a trigger frame issued by an AP or whether this is a trigger frame issued by a STA. A configuration can be adopted in which in a case where it is indicated in the repurposed field that this is a trigger frame issued by a STA and also "0" is indicated in the AID12 subfield, this is regarded as a TXS TF addressed to an AP. In another modified example, a configuration can be adopted in which in a case where it is indicated in the repurposed field that this is a trigger frame issued by a STA and also "2045" is indicated in the AID12 subfield, this is regarded as a TXS TF addressed to an AP. It is noted that in a case where the repurposed field indicates that this is a trigger frame issued by an AP, a configuration may be adopted in which "0" or "2045" is regarded as an RA-RU as before.

In addition, according to the above-described embodiment, a case has been supposed where the Common Info field and the User Info field are EHT Variant fields, but is not limited to this, and a UHR Variant Common Info field and a UHR Variant User Info field may also be used.

In addition, according to the above-described embodiment, a case has been described where another communication device with which a TXOP is shared is an AP, but is not limited to this. For example, the technique can also be used in sharing of a TXOP in a case where a STA and another STA establish a direct link to perform communication.

For example, in a case where the STA 102 establishes a direct link with the STA 103, the above-described TXS TF can be transmitted from the STA 102 which has owned the TXOP to the STA 103 to share the TXOP.

In addition, the STA 102 may be a device operating as a client of Wi-Fi Direct (registered trademark), and another communication device may be a communication device operating as a group owner of the Wi-Fi Direct to which the STA 102 is connected. In this case, the STA 102 can transmit a TXS TF to the other communication device operating as the group owner of the Wi-Fi Direct to share a TXOP with the group owner.

In this case, since the group owner is an entity operating like an AP, the above-described value indicating that this is addressed to the AP may be set in the AID12 subfield. As described above, it is also possible to provide the above-described scheme to sharing of the transmission opportunity in peer-to-peer (P2P) communication such as a direct link or Wi-Fi Direct.

### Other Embodiment 1

In addition, the disclosure of the present embodiment has the following configurations.

### Configuration 1

A station device connectable to an access point device, the station device including:

a transmission control unit configured to transmit, in a case where the station device owns a transmission opportunity, an MU-RTS TXS Trigger frame for sharing the transmission opportunity to another communication device.

### Configuration 2

The station device according to configuration 1, in which the other communication device is an access point device to which the station device is connected.

### Configuration 3

The station device according to configuration 1 or 2, in which a specific value that does not fall within a range from 0 to 2007 is stored in an AID12 subfield of a User Info field of the MU-RTS TXS Trigger frame for sharing the transmission opportunity with the access point device.

### Configuration 4

The station device according to configuration 1, in which the other communication device is another station device to which a direct link is established by the station device.

### Configuration 5

The station device according to any one of configurations 1 to 3, in which 2 is set in a Triggered TXOP Sharing Mode subfield of the MU-RTS TXS Trigger frame.

### Configuration 6

The station device according to any one of configurations 1 to 3, in which 3 is set in a Triggered TXOP Sharing Mode subfield of the MU-RTS TXS Trigger frame.

### Configuration 7

The station device according to configuration 5 or 6, in which in a case where a frame including a CAS Control field is received from the other communication device that is a frame in which 0 is set in an RDG/More PPDU subfield included in the CAS Control field and a case where data that is to be transmitted is stored in a buffer, the transmission control unit transmits a frame including the data that is to be transmitted towards a destination of the data that is to be transmitted.

### Configuration 8

The station device according to any one of configurations 1 to 7, in which the MU-RTS TXS Trigger frame includes an EHT Variant User Info field.

### Configuration 9

The station device according to any one of configurations 1 to 7, in which the MU-RTS TXS Trigger frame includes a UHR Variant User Info field.

### Configuration 10

The station device according to any one of configurations 1 to 8, in which in a case where the transmission opportunity is owned and a case where data that is to be transmitted to the access point device is stored in a buffer, the transmission control unit transmits a frame in a UHR PPDU format including the data to the access point device.

### Configuration 11

The station device according to any one of configurations 1 to 9, in which the station device is a device configured to operate as a client of Wi-Fi Direct (registered trademark), and the other communication device transmits the MU-RTS TXS Trigger frame to the other communication device serving as a group owner of the Wi-Fi Direct to which the station device is connected.

### Configuration 12

An access point device including:

a reception control unit configured to receive, in a case where a station device connected to the access point device owns a transmission opportunity, an MU-RTS TXS Trigger frame for sharing the transmission opportunity with the access point device from the station device; and

a transmission control unit configured to transmit, after the MU-RTS TXS Trigger frame is received, during a duration of the transmission opportunity shared based on the MU-RTS TXS Trigger frame, a data frame to another communication device.

### Configuration 13

The access point device according to configuration 12, in which during the duration of the transmission opportunity shared based on the MU-RTS TXS Trigger frame, even in a case where the data frame has been successively transmitted to the other communication device, the access point device does not change an EDCA parameter to be used in a contention access to a parameter corresponding to an MU EDCA parameter.

### Configuration 14

A control method of a station device connectable to an access point device, the control method including:

performing, in a case where the station device owns a transmission opportunity, transmission control to transmit an MU-RTS TXS Trigger frame for sharing the transmission opportunity to another communication device.

### Configuration 15

A control method of an access point device, the control method including:

performing, in a case where a station device connected to the access point device owns a transmission opportunity, reception control to receive an MU-RTS TXS Trigger frame for sharing the transmission opportunity with the access point device from the station device; and

performing, after the MU-RTS TXS Trigger frame is received, during a duration of the transmission opportunity shared based on the MU-RTS TXS Trigger frame, transmission control to transmit a data frame to another communication device.

### Configuration 16

A program for causing a computer to execute the control method of the station device according to configuration 14.

### Configuration 17

A program for causing a computer to execute the control method of the access point device according to configuration 15.

According to an aspect of the present disclosure, it becomes possible to provide the scheme with which the transmission opportunity owned by the station device is shared with another communication device.

### Other Embodiment 2

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A station device connectable to an access point device, the station device comprising:
at least one memory that stores a set of instructions; and
at least one processor that executes the instructions, the instructions, when executed, causing the station device to perform operations comprising:
controlling, in a case where the station device owns a transmission opportunity, transmission of an MU-RTS TXS Trigger frame for sharing the transmission opportunity to another communication device.

2. The station device according to claim 1, wherein the other communication device is an access point device to which the station device is connected.

3. The station device according to claim 1, wherein a specific value that does not fall within a range from 0 to 2007 is stored in an AID12 subfield of a User Info field of the MU-RTS TXS Trigger frame for sharing the transmission opportunity with the access point device.

4. The station device according to claim 1, wherein the other communication device is another station device to which a direct link is established by the station device.

5. The station device according to claim 1, wherein 2 is set in a Triggered TXOP Sharing Mode subfield of the MU-RTS TXS Trigger frame.

6. The station device according to claim 1, wherein 3 is set in a Triggered TXOP Sharing Mode subfield of the MU-RTS TXS Trigger frame.

7. The station device according to claim 5, wherein in a case where a frame including a CAS Control field is received from the other communication device that is a frame in which 0 is set in an RDG/More PPDU subfield included in the CAS Control field and a case where data that is to be transmitted is stored in a buffer, the station device transmits a frame including the data that is to be transmitted towards a destination of the data that is to be transmitted.

8. The station device according to claim 6, wherein in a case where a frame including a CAS Control field is received from the other communication device that is a frame in which 0 is set in an RDG/More PPDU subfield included in the CAS Control field and a case where data that is to be transmitted is stored in a buffer, the station device transmits a frame including the data that is to be transmitted towards a destination of the data that is to be transmitted.

9. The station device according to claim 1, wherein the MU-RTS TXS Trigger frame includes an EHT Variant User Info field.

10. The station device according to claim 1, wherein the MU-RTS TXS Trigger frame includes a UHR Variant User Info field.

11. The station device according to claim 1, wherein in a case where the transmission opportunity is owned and a case where data that is to be transmitted to the access point device is stored in a buffer, the station device transmits a frame in a UHR PPDU format including the data to the access point device.

12. The station device according to claim 1, wherein the station device is a device configured to operate as a client of Wi-Fi Direct (registered trademark), and the other communication device transmits the MU-RTS TXS Trigger frame to the other communication device serving as a group owner of the Wi-Fi Direct to which the station device is connected.

13. An access point device comprising:
at least one memory that stores a set of instructions; and
at least one processor that executes the instructions, the instructions, when executed, causing the access point device to perform operations comprising:
receiving, in a case where a station device connected to the access point device owns a transmission opportunity, an MU-RTS TXS Trigger frame for sharing the transmission opportunity with the access point device from the station device; and
controlling, after the MU-RTS TXS Trigger frame is received, during a duration of the transmission opportunity shared based on the MU-RTS TXS Trigger frame, transmission of a data frame to another communication device.

14. The access point device according to claim 13, wherein during the duration of the transmission opportunity shared based on the MU-RTS TXS Trigger frame, even in a case where the data frame has been successively transmitted to the other communication device, the access point device does not change an EDCA parameter to be used in a contention access to a parameter corresponding to an MU EDCA parameter.

15. A control method of a station device connectable to an access point device, the control method comprising:
controlling, in a case where the station device owns a transmission opportunity, transmission of an MU-RTS TXS Trigger frame for sharing the transmission opportunity to another communication device.

16. A control method of an access point device, the control method comprising:
performing, in a case where a station device connected to the access point device owns a transmission opportunity, reception control to receive an MU-RTS TXS Trigger frame for sharing the transmission opportunity with the access point device from the station device; and
performing, after the MU-RTS TXS Trigger frame is received, during a duration of the transmission opportunity shared based on the MU-RTS TXS Trigger frame, transmission control to transmit a data frame to another communication device.

17. A non-transitory computer readable storage medium that stores a program that causes, when the program is executed, a station device connectable to an access point device to perform:
controlling, in a case where the station device owns a transmission opportunity, transmission of an MU-RTS TXS Trigger frame for sharing the transmission opportunity to another communication device.

18. A non-transitory computer readable storage medium that stores a program that causes, when the program is executed, an access point device to perform:
performing, in a case where a station device connected to the access point device owns a transmission opportunity, reception control to receive an MU-RTS TXS Trigger frame for sharing the transmission opportunity with the access point device from the station device; and
performing, after the MU-RTS TXS Trigger frame is received, during a duration of the transmission opportunity shared based on the MU-RTS TXS Trigger frame, transmission control to transmit a data frame to another communication device.
